(19) United States
(12) Patent Application Publication
(10) Pub. No.: US 2006/0064177 A1
(43) Pub. Date: Mar. 23, 2006

(54) System and method for measuring confusion among words in an adaptive speech recognition system

(75) Inventors: Jilei Tian, Tampere (FI); Sunil Sivadas, Tampere (FI); Tommi Lahti, Tampere (FI)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 11/148,469

(22) Filed: Jun. 9, 2005

Related U.S. Application Data
(63) Continuation-in-part of application No. 10/944,517, filed on Sep. 17, 2004.

(51) Int. Cl. G05B 15/00

(52) U.S. Cl. 700/1

(57) ABSTRACT

A system and method are proposed for measuring confusability or similarity between given entry pairs, including text string pairs and acoustic model pairs, in systems such as speech recognition and synthesis systems. A string edit distance (Levenshiten distance) can be applied to measure distance between any pair of text strings. It also can be used to calculate a confusion measurement between acoustic model pairs of different words and a model-driven method can be used to calculate a HMM model confusion matrix. This model-based approach can be efficiently calculated with low memory and low computational resources. Thus it can improve the speech recognition performance and models trained from text corpus.

### CROSS REFERENCE TO RELATED APPLICATIONS

This application is a continuation-in-part of U.S. patent application Ser. No. 10/944,517, filed Sep. 17, 2004 and incorporated herein by reference in its entirety.

### FIELD OF THE INVENTION

The present invention is related to Automatic Speech Recognition (ASR) and Text-to-Speech (TTS) synthesis technology. More specifically, the present invention relates to the optimization of text-based training set selection for the training of language processing modules used in ASR or TTS systems, or in vector quantization of text data, etc., as well as the measurement of confusability or similarity between words or word groups by such speech recognition systems.

### BACKGROUND OF THE INVENTION

ASR technologies allow computers equipped with microphones to interpret human speech for transcription of the speech or for use in controlling a device. For example, a speaker-independent name dialer for mobile phones is one of the most widely distributed ASR applications in the world. In a voice dialing application, the user is allowed to add names to the system. The names can be added in text using a keypad, loaded into the system from a file, spoken by the speaker or acquired using other input devices such as an optical character recognizer or scanner. As another example, speech controlled vehicular navigation systems can also be implemented.

A TTS synthesizer is a computer-based system that is designed to read text aloud by automatically creating sentences through a Grapheme-to-Phoneme (GTP) transcription of the sentences. The process of assigning phonetic transcriptions to words is called Text-to-Phoneme (TTP) or GTP conversion.

In typical ASR or TTS systems, there are several data-driven language processing modules that have to be trained using text-based training data. For example, in the data-driven syllable detection, the model may be trained using a manually annotated database. Data-driven approaches (i.e., neural networks, decision trees, n-gram models) are also commonly used for modeling the language-dependent pronunciations in many ASR and TTS systems. The model is typically trained using a database that is a subset of a pronunciation dictionary containing GTP or TTP entries. One of the reasons for using just a subset is that it is impossible to create a dictionary containing the complete vocabulary for most of the languages. Yet another example of a trainable module is the text-based language identification task, in which the model is usually trained using a database that is a subset of a multilingual text corpus that consists of text entries among the target languages.

Additionally, the digital signal processing technique of vector quantization that may be applicable to any number of applications, for instance ASR and TTS systems, utilizes a database. The database contains a representative set of actual data that is used to compute a codebook, which can define the centroids or meaningful clustering in the vector space. Using vector quantization, an infinite variety of possible data vectors may be represented using the relatively small set of vectors contained in the codebook. The traditional vector quantization or clustering techniques designed for numerical data cannot be directly applied in cases where the data consists of text strings. The method described in this document provides an easy approach for clustering text data. Thus, it can be considered as a technique for enabling text string vector quantization.

The performance of the models mentioned above depends on the quality of the text data used in the training process. As a result, the selection of the database from the text corpus plays an important role in the development of these text processing modules. In practice, the database contains a subset of the entire corpus and should be as small as possible for several reasons. First, the larger the size of the database, the greater the amount of time required to develop the database and the greater the potential for errors or inconsistencies in creating the database. Second, for decision tree modeling, the model size depends on the database size, and thus, impacts the complexity of the system. Third, the database size may require balancing among other resources. For example, in the training of a neural network the number of entries for each language should be balanced to avoid a bias toward a certain language. Fourth, a smaller database size requires less memory, and enables faster processing and training.

The database selection from a corpus currently is performed arbitrarily or using decimation on a sorted data corpus. One other option is to do the selection manually. However, this requires a skilled professional, is very time consuming and the result could not be considered an optimal one. As a result, the information provided by the database is not optimized. The arbitrary selection method depends on random selections from the entire corpus without consideration for any underlying characteristics of the text data. The decimation selection method uses only the first characters of the strings, and thus, does not guarantee good performance. Thus, what is needed is a method and a system for optimally selecting entries for a database from a corpus in such a manner that the context coverage of the entire corpus is maximized while minimizing the size of the database.

In a multilingual speaker independent speech recognition system, a set of acoustic models corresponding subword units, such as phonemes, are used to cover the languages and are trained and stored in the memory of the device. When a user adds a new word, the language identification unit identifies a number of languages to which the word may belong. The next step involves the conversion of the word into a sequence of subword units using an appropriate on-line pronunciation-modeling mechanism. A pronunciation is generated for each likely language. When the user wants to dial a name from the list in a dialing application, he or she states the corresponding name. The spoken word is converted into a sequence of subword units by the speech recognizer. The stored models are adapted each time that the user speaks a word. This adaptation reduces the mismatch between the pre-trained acoustic models and the user's speech, thus enhancing the performance.

Current adaptive subword unit-based, speaker-independent, isolated word recognition systems currently do not effectively use interactive capability. The errors made by a speech recognition system depend on the level of confusability of the application's vocabulary. The more confusable entries in the vocabulary, the higher the number of errors that will likely exist. When the number of words is quite large, it becomes much more likely that a user will attempt to enter either a name or a word that sounds very similar to another previous entry, or that the user may try to enter a duplicate name that already exists in the vocabulary.

U.S. Pat. No. 5,737,723, issued to Riley et al. on Apr. 7, 1998, discusses a method for detecting confusable words for training an isolated word recognition system. The acoustic confusion between words is measured using pre-computed phoneme confusion measures. The phoneme confusion measures are obtained offline from a training set. Although moderately useful, this system includes a number of drawbacks. Because this system uses a pre-calculated table of confusion measure, it cannot work on adaptive systems in which models are updated on-line. Additionally, this system is restricted to a specific application that identifies and/or rejects confusable words during the training of a word-based speech recognition system. The system is also intended for designing vocabulary during the training of a speech recognition system. Once the system is trained, it is not updated. Finally, this system does not address the issue of a multilingual speaker-independent speech recognition system. The entered word can have multiple pronunciations based on the language.

### SUMMARY OF THE INVENTION

One embodiment of the present invention relates to a method of selecting a database from a corpus using an optimization function. The method includes, but is not limited to, defining a size of a database, calculating a coefficient using a distance function for each pair in a set of pairs, and executing an optimization function using the distance to select each entry saved in the database until the number of entries of the database equals the size of the database. In the beginning, each pair in the set of pairs includes a first entry selected from a corpus and a second entry selected from the corpus. After the first iteration, the second entry can be selected from the set of previously selected entries (i.e. the database) and the first entry can be selected from the rest of the corpus. The set of pairs includes each combination of the first entry and the second entry.

Executing the optimization function may include, but is not limited to, (a) selecting an initial pair of entries from the set of pairs, wherein the distance of the initial pair is greater than or equal to the distance calculated for each pair in the set of pairs; (b) moving the initial pair into the database; (c) identifying a new entry from the corpus, for which the average distance to the entries in the database is greater than or equal to the similar average distances calculated for all the other entries in the corpus; (d) moving the chosen entry from the corpus into the database; and (e) if a number of entries of the database is less than the size of the database, repeating (c) and (d).

Another embodiment of the invention relates to a computer program product for training a language processing module using a database selected from a corpus using an optimization function. The computer program product includes, but is not limited to, computer code configured to calculate a coefficient using a distance function for each pair in a set of pairs, to execute an optimization function using the distance to select each entry saved in a database until a number of entries of the database equals a size defined for the database, and to train a language processing module using the database. The coefficient may comprise, but is not limited to, distance. Each pair in the set of pairs includes either two entries selected from a corpus or one entry selected from the set of previously selected entries (i.e. the database) and another entry selected from the rest of the corpus.

The computer code configured to execute the optimization function may include, but is not limited to, computer code configured to (a) select an initial pair of entries from the set of pairs, wherein the distance of the initial pair is greater than or equal to the distance calculated for each pair in the set of pairs; (b) moving the initial pair into the database; (c) identifying a new entry from the corpus, for which the average distance to the entries in the database is greater than or equal to the similar average distances calculated for all the other entries in the corpus; (d) moving the chosen entry from the corpus into the database; and (e) if a number of entries of the database is less than the size of the database, repeating (c) and (d).

Still another embodiment of the invention relates to a device for selecting a database from a corpus using an optimization function. The device includes, but is not limited to, a database selector, a memory, and a processor. The database selector includes, but is not limited to, computer code configured to calculate a coefficient using a distance function for each pair in a set of pairs and to execute an optimization function using the distance to select each entry saved in a database until a number of entries of the database equals a size defined for the database. The coefficient may comprise, but is not limited to, distance. Each pair in the set of pairs includes either two entries selected from a corpus or one entry selected from the set of previously selected entries (i.e. the database) and another entry selected from the rest of the corpus. The memory stores the training database selector. The processor couples to the memory and is configured to execute the database selector.

The device configured to execute the optimization function may include, but is not limited to, device configured to a: (a) select an initial pair of entries from the set of pairs, wherein the distance of the initial pair is greater than or equal to the distance calculated for each pair in the set of pairs; (b) moving the initial pair into the database; (c) identifying a new entry from the corpus, for which the average distance to the entries in the database is greater than or equal to the similar average distances calculated for all the other entries in the corpus; (d) moving the chosen entry from the corpus into the database; and (e) if a number of entries of the database is less than the size of the database, repeating (c) and (d).

Still another embodiment of the invention relates to a system for processing language inputs to determine an output. The system includes, but is not limited to, a database selector, a language processing module, one or more memory, and one or more processor. The database selector includes, but is not limited to, computer code configured to calculate a distance using a distance function for each pair in a set of pairs and to execute an optimization function using the distance to select each entry saved in a database until a number of entries of the database equals a size defined for the database. The coefficient may comprise, but is not limited to, distance. Each pair in the set of pairs includes either two entries selected from a corpus or one entry selected from the set of previously selected entries (i.e. the training set) and another entry selected from the rest of the corpus.

The language processing module is trained using the database and includes, but is not limited to, computer code configured to accept an input and to associate the input with an output. The one or more memory stores the database selector and the language processing module. The one or more processor couples to the one or more memory and is configured to execute the database selector and the language processing module.

The computer code configured to execute the optimization function may include, but is not limited to, computer code configured to: (a) select an initial pair of entries from the set of pairs, wherein the distance of the initial pair is greater than or equal to the distance calculated for each pair in the set of pairs; (b) moving the initial pair into the database; (c) identifying a new entry from the corpus, for which the average distance to the entries in the database is greater than or equal to the similar average distances calculated for all the other entries in the corpus; (d) moving the chosen entry from the corpus into the database; and (e) if a number of entries of the database is less than the size of the database, repeating (c) and (d).

A further embodiment of the invention relates to a module configured for selecting a database from a corpus, the module configured to: (a) define a size of a database; (b) calculate a coefficient for at least one pair in a set of pairs; and (c) execute a function to select each entry to be saved in the database until a number of entries of the database equals the size of the database.

The present invention also provides for an improved system and method for measuring the confusability or similarity between given entry pairs. By having an objective measure of confusability or similarity, a system incorporating the present invention can provide a message to the user whenever a new name is added that is confusable with an existing entry in the contact list. This information gives the user the opportunity to change the name if necessary. As a result of this feature, the level of performance for the respective speech recognition application can be greatly enhanced.

Compared to conventional systems, the present invention provides a more realistic measure of similarity between words by computing the distance between acoustic models that are continuously adapted to a user's speech and environment. The present invention also incorporates an efficient method to generate pronunciations based on a few likely languages to which the word may belong.

These and other objects, advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a block diagram of a language processing module training sequence in accordance with an exemplary embodiment;

FIG. 2 is a block diagram of a device that may host the language processing module training sequence of FIG. 1 in accordance with an exemplary embodiment;

FIG. 3 is an overview diagram of a system that may include the device of FIG. 2 in accordance with an exemplary embodiment;

FIG. 4 is a first diagram comparing the accuracy of the language processing module wherein the language processing module has been trained using two different database selectors to select the database;

FIG. 5 is a second diagram comparing the average distance among entries in the database selected by the two different database selectors;

FIG. 6 is a flow chart showing steps involved in the design of a speaker independent multilingual isolated word recognition system according to the present invention;

FIG. 7 is a flow chart representing the process of entering a new word into a word recognition system according to one embodiment of the present invention; and

FIG. 8 is a flow chart showing the steps involved in dialing a name or activating an item in an application according to one embodiment of the present invention.

### DETAILED DESCRIPTION OF THE PREFERRED EMBODIMENTS

The term “text” as used in this disclosure refers to any string of characters including any graphic symbol such as an alphabet, a grapheme, a phoneme, an onset-nucleus-coda (ONC) syllable representation, a word, a syllable, etc. A string of characters may be a single character. The text may include a number or several numbers.

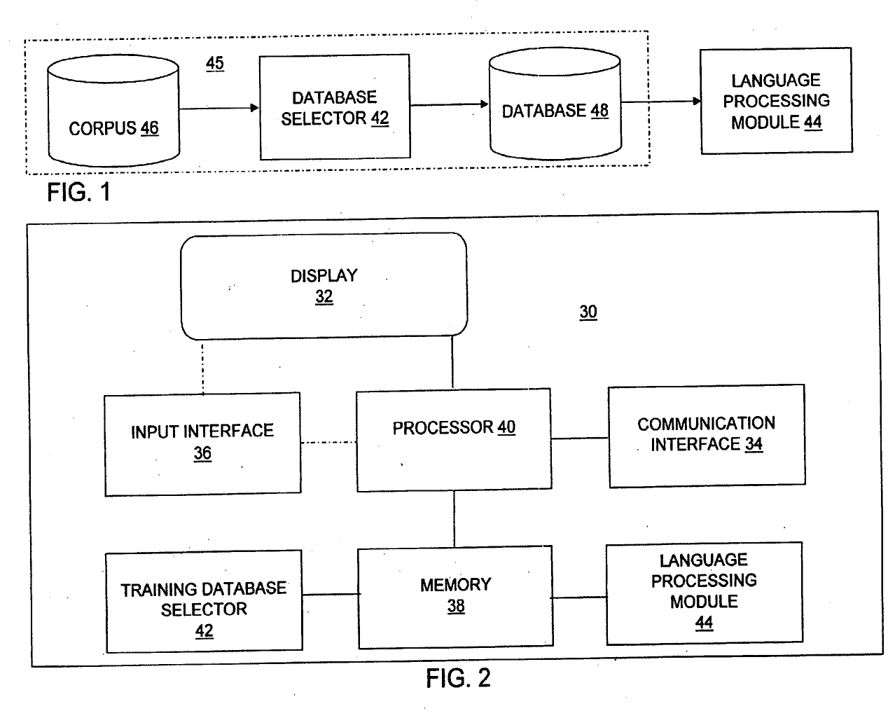

With reference to FIG. 1, a database selection process 45 for training a language processing module 44 is shown. The language processing module 44 may include, but is not limited to, an ASR module, a TTS synthesis module, and a text clustering module. The database selection process 45 includes, but is not limited to, a corpus 46, a database selector 42, and a database 48. The corpus 46 may include any number of text entries. The database selector 42 selects text from the corpus 46 to create the database 48. The database selector 42 may be used to extract text data from the corpus 46 to define the database 48, and/or to cluster text data from the corpus 46 as in the selection of the database 48 to form a vector codebook. In addition, an overall distance measure for the corpus 46 can be determined. The database 48 may be used for training language processing modules 44 for subsequent speech to text or text to speech transformation or may define a vector codebook for vector quantization of the corpus 46.

The database selector 42 may include an optimization function to optimize the database 48 selection. To optimize the selection of entries into the database 48, a distance may be defined among text entries in the corpus 46. For example, an edit distance is a widely used metric for determining the dissimilarity between two strings of characters. The edit operations most frequently considered are the deletion, insertion, and substitution of individual symbols in the strings of characters to transform one string into the other. The Levenshtein distance between two text entries is defined as the minimum number of edit operations required to transform one string of characters into another. In the Generalized Levenshtein Distance (GLD), the edit operations may be weighted using a cost function for each basic transformation and generalized using edit distances that are symbol dependent.

The Levenshtein distance is characterized by the cost functions: w(a, ε)=1; w(ε, b)=1; and w(a, b)=0 if a is equal to b, and w(a, b)=1 otherwise; where w(a, ε) is the cost of deleting a, w(ε, b) is the cost of inserting b, and w(a, b) is the cost of substituting symbol a with symbol b. Using the GLD, different costs may be associated with transformations that involve different symbols. For example, the cost w(x, y) to substitute x with y may be different than the cost w(x, z) to substitute x with z. If an alphabet has s symbols, a cost table of size (s+1) by (s+1) may store all of the substitution, insertion, and deletion costs between the various transformations in a GLD.

Thus, the Levenshtein distance or the GLD may be used to measure the distance between any pair of entries in the corpus 46. Similarly, the distance for the entire corpus 46 may be calculated by averaging the distance calculated between each pair selected from all of the text entries in the corpus 46. Thus, if the corpus 46 includes m entries, the ith entry is denoted by e(i) and the jth entry is denoted by e(j), the distance for the entire corpus 46 may be calculated as:

$$D = \frac{2 \cdot {\sum }_{i = 1}^{m} {\sum }_{j > i}^{m} ld ( e ( i ) , e ( j ) )}{m \cdot ( m - 1 )}$$

The optimization function of the database selector 42 may recursively select the next entry in the database 48 as the text entry that maximizes the average distance between all of entries in the database 48 and each of the text entries remaining in the corpus 46. For example, the optimization function may calculate the Levenshtein distance ld(e(i), e(j)) for a set of pairs that includes each text entry in the database 48 paired with each other text entry in the database 48. The set of pairs optionally may not include the combination wherein the first entry is the same as the second entry. The optimization function may select the text entries e(i), e(j) of the text entry pair (e(i), e(j)) having the maximum Levenshtein distance ld(e(i), e(j)) as subset_e(1) and subset_e(2), the initial text entries in the database 48. The database selector 42 saves the text entries subset_e(1) and subset_e(2) in the database 48. The optimization function may identify the text entry selection e(i) that approximately maximizes the amount of new information brought into the database 48 using the following formula where k denotes the number of text entries in the database 48. Then p entry from corpus is selected and added into the database as k+1 entry.

$$p = {argmax}_{( l \leq i \leq m )} \{ {\sum }_{j = 1 , e ( i ) \neq subset\_e ( j )}^{k} ld ( e ( i ) , subset\_e ( j ) \}$$

Thus, the optimization function selects the text entry e(i) of the corpus having the maximum Levenshtein distance sum

$${\sum }_{j = 1 , e ( i ) \neq subset\_e ( j )}^{k} ld ( e ( i ) , subset\_e ( j )$$

as subset_e(k+1), the (k+1)^{th} text entry in the database 48. The database selector 42 saves the text entry subset_e(k+1) in the database 48. The database selector 42 saves text entries to the database 48 until the number of entries k of the database 48 equals a size defined for the database 48.

In an exemplary embodiment, the device 30, as shown in FIG. 2, may include, but is not limited to, a display 32, a communication interface 34, an input interface 36, a memory 38, a processor 40, the database selector 42, and the language processing module 44. The display 32 presents information to a user. The display 32 may be, but is not limited to, a thin film transistor (TFT) display, a light emitting diode (LED) display, a Liquid Crystal Display (LCD), a Cathode Ray Tube (CRT) display, etc.

The communication interface 34 provides an interface for receiving and transmitting calls, messages, and any other information communicable between devices. The communication interface 34 may use various transmission technologies including, but not limited to, CDMA, GSM, UMTS, TDMA, TCP/IP, GPRS, Bluetooth, IEEE 802.11, etc. to transfer content to and from the device.

The input interface 36 provides an interface for receiving information from the user for entry into the device 30. The input interface 36 may use various input technologies including, but not limited to, a keyboard, a pen and touch screen, a mouse, a track ball, a touch screen, a keypad, one or more buttons, speech, etc. to allow the user to enter information into the device 30 or to make selections. The input interface 36 may provide both an input and output interface. For example, a touch screen both allows user input and presents output to the user.

The memory 38 may be the electronic holding place for the operating system, the database selector 42, and the language processing module 44, and/or other applications and data including the corpus 46 and/or the database 48 so that the information can be reached quickly by the processor 40. The device 30 may have one or more memory 38 using different memory technologies including, but not limited to, Random Access Memory (RAM), Read Only Memory (ROM), flash memory, etc. The database selector 42, the language processing module 44, the corpus 46, and/or the database 48 may be stored by the same memory 38. Alternatively, the database selector 42, the language processing module 44, the corpus 46, and/or the database 48 may be stored by different memories 38. It should be understood that the database selector 42 may also be stored someplace outside of device 30.

The database selector 42 and the language processing module 44 are organized sets of instructions that, when executed, cause the device 30 to behave in a predetermined manner. The instructions may be written using one or more programming languages, assembly languages, scripting languages, etc. The database selector 42 and the language processing module 44 may be written in the same or different computer languages including, but not limited to high level languages, scripting languages, assembly languages, etc.

The processor 40 may retrieve a set of instructions such as the database selector 42 and the language processing module 44 from a non-volatile or a permanent memory and copy the instructions in an executable form to a temporary memory. The processor 40 executes an application or a utility, meaning that it performs the operations called for by that instruction set. The processor 40 may be implemented as a special purpose computer, logic circuits, hardware circuits, etc. Thus, the processor 40 may be implemented in hardware, firmware, software, or any combination of these methods. The device 30 may have one or more processor 40. The database selector 42, the language processing module 44, the operating system, and other applications may be executed by the same processor 40. Alternatively, the database selector 42, the language processing module 44, the operating system, and other applications may be executed by different processors 40.

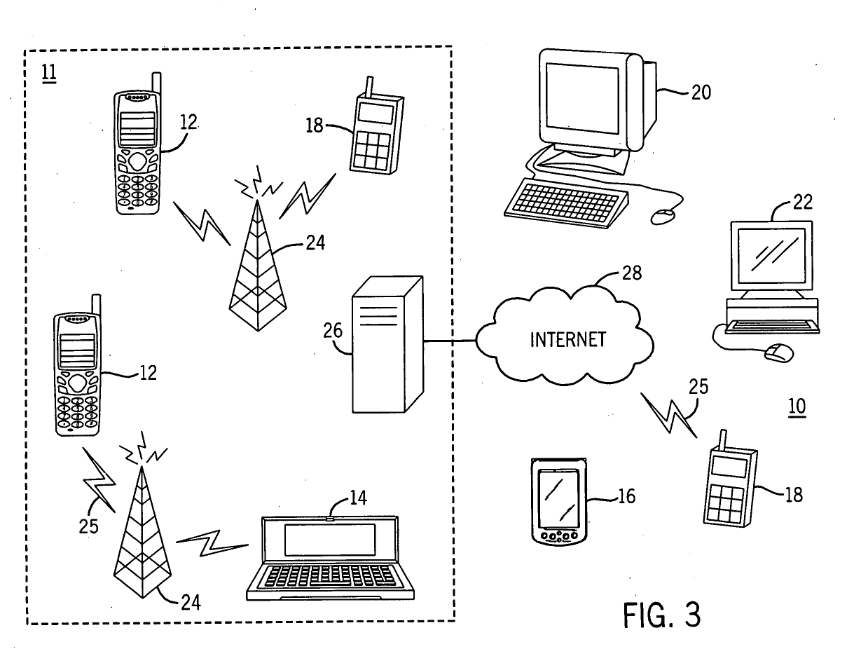

With reference to FIG. 3, the system 10 is comprised of multiple devices that may communicate with other devices using a network. The system 10 may comprise any combination of wired or wireless networks including, but not limited to, a cellular telephone network, a wireless Local Area Network (LAN), a Bluetooth personal area network, an Ethernet LAN, a token ring LAN, a wide area network, the Internet, etc. The system 10 may include both wired and wireless devices. For exemplification, the system 10 shown in FIG. 1 includes a cellular telephone network 11 and the Internet 28. Connectivity to the Internet 28 may include, but is not limited to, long range wireless connections, short range wireless connections, and various wired connections including, but not limited to, telephone lines, cable lines, power lines, and the like.

The exemplary devices of the system 10 may include, but are not limited to, a cellular telephone 12, a combination Personal Data Assistant (PDA) and cellular telephone 14, a PDA 16, an integrated communication device 18, a desktop computer 20, and a notebook computer 22. Some or all of the devices may communicate with service providers through a wireless connection 25 to a base station 24. The base station 24 may be connected to a network server 26 that allows communication between the cellular telephone network 11 and the Internet 28. The system 10 may include additional devices and devices of different types.

The optimization function of the database selector 42 has been verified in a syllabification task. Syllables are basic units of words that comprise a unit of coherent grouping of discrete sounds. Each syllable is typically composed of more than one phoneme. The syllable structure grammar divides each syllable into onset, nucleus, and coda. Each syllable includes a nucleus that can be either a vowel or a diphthong. The onset is the first part of a syllable consisting of consonants that precede the nucleus of the syllable. The coda is the part of a syllable that follows the nucleus. For example, given the syllable [t eh k s t], /t/ is the onset, /eh/ is the nucleus, and /k s t/ is the coda. For training a data-driven syllabification model, phoneme sequences are mapped into their ONC representation. The model is trained on the mapping between pronunciations and their ONC representation. Given a phoneme sequence in the decoding phase after training of the model, the ONC sequence is generated, and the syllable boundaries are uniquely decided based on the ONC sequence.

The syllabification task used to verify the utility of the optimization function included the following steps:
1. Pronunciation phoneme strings were mapped into ONC strings, for example: (word) “text”->(pronunciation) “t eh k s t”->(ONC) “O N C C C”
2. The language processing module was trained on the data in the format of “pronunciation->ONC”
3. Given the pronunciation, the corresponding ONC sequence was generated from the language processing module. The syllable boundaries were placed at the location starting with a symbol “O” or “N” if the syllable is not preceded with a symbol “O”.

The neural network-based ONC model used was a standard two-layer multi-layer perception (MLP). Phonemes were presented to the MLP network one at a time in a sequential manner. The network determined an estimate of the ONC posterior probabilities for each presented phoneme. In order to take the phoneme context into account, neighboring (e.g. context size of 4) phonemes from each side of the target phoneme were used as input to the network. A context size of four phonemes was used. Thus, a window of p-4 . . . p4 phonemes centered at phoneme p0 was presented to the neural network as input. The centermost phoneme p0 was the phoneme that corresponded to the output of the network. Therefore, the output of the MLP was the estimated ONC probability for the centermost phoneme p0 in the given context p-4 . . . p4. The ONC neural network was a fully connected MLP that used a hyperbolic tangent sigmoid shaped function in the hidden layer and a softmax normalization function in the output layer. The softmax normalization ensured that the network outputs were in the range [0,1] and summed to unity.

The neural network based syllabification task was evaluated using the Carnegie-Mellon University (CMU) dictionary for US English as the corpus 46. The dictionary contained 10,801 words with pronunciations and labels including the ONC information. The pronunciations and the mapped ONC sequences were selected from the corpus 46 that comprised the CMU dictionary to form the database 48. The database 48 was selected from the entire corpus using a decimation function and the optimization function. The test set included the data in the corpus not included in the database 48.

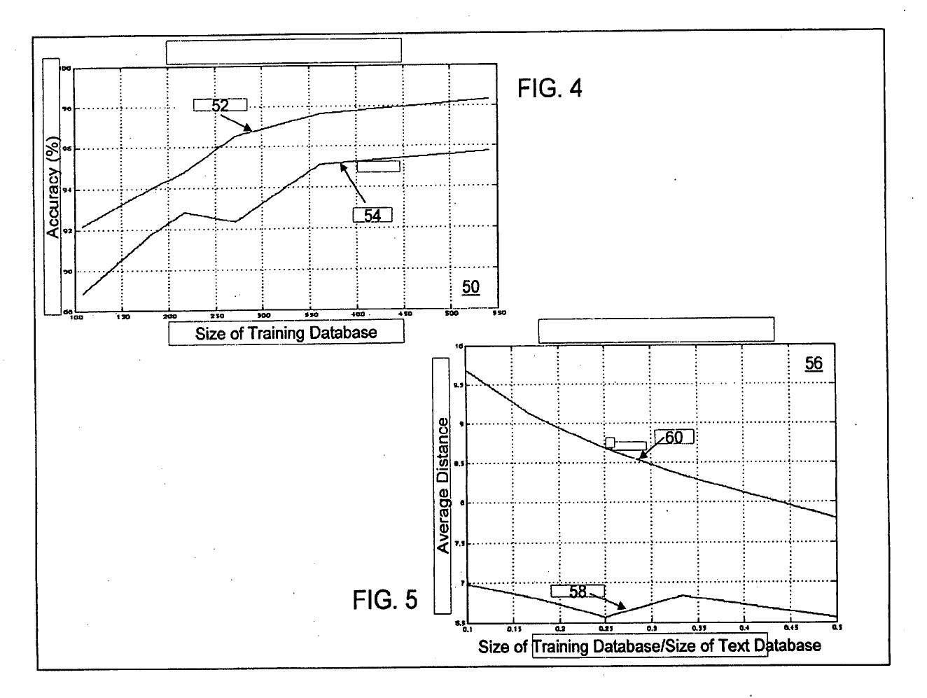

FIG. 4 shows a comparison 50 of the experimental results achieved using the two data different database selection functions, decimation and optimization. The comparison 50 includes a first curve 52 and a second curve 54. The first curve 52 depicts the results achieved using the decimation function for selecting the database. The second curve 54 depicts the results achieved using the optimization function for selection of the database. The first curve 52 and the second curve 54 represent the accuracy of the language processing module trained using the database selected using each selection function. The accuracy is the percent of correct ONC sequence identifications and syllable boundary identifications achieved given a pronunciation from the CMU dictionary test set.

In general, the greater the size of the database, the better the performance of the language processing module. The results show that the optimization function outperformed the decimation function. The average improvement achieved using the optimization function was 38.8% calculated as Improvement rate=((decimation error rate−optimization error rate)/decimation error rate)×100%. Thus, for example, given a database size of 300 words, the decimation function achieved an accuracy of ˜93% in determining the ONC sequence given the pronunciation as an input. Using the same database size of 300 words, the optimization function achieved an accuracy of ˜97%. Thus, the selection of the database affected the generalization capability of the language processing module. Because the database was quasi-optimally selected, the accuracy was improved without increasing the size of the database.

FIG. 5 shows a comparison 56 of the average distance of the database achieved using the two data different database selection functions. The comparison 56 includes a third curve 58 and a fourth curve 60. The third curve 58 depicts the results achieved using the decimation function for selecting the database. The fourth curve 60 depicts the results achieved using the optimization function for selection of the database. The third curve 58 and the fourth curve 60 represent the average distance of the database selected using each function. An increase in average distance indicates an increase in the expected coverage of the corpus by the database selected. The average distance within the database selected using the decimation function was approximately evenly distributed varying by less than 0.5 as the database size relative to the enter corpus increased. In comparison, the average distance within the database selected using the optimization function decreased monotonically with increasing database size. Thus, the difference in the average distance calculated increased as the database size was reduced. As expected, the difference in the average distance calculated converged to zero as the database size increased to include more of the entire corpus. Thus, the verification results indicate that the described optimization function extracts data more efficiently from the corpus so that the selected database provides better coverage of the corpus and ultimately improves the accuracy of the language processing module.

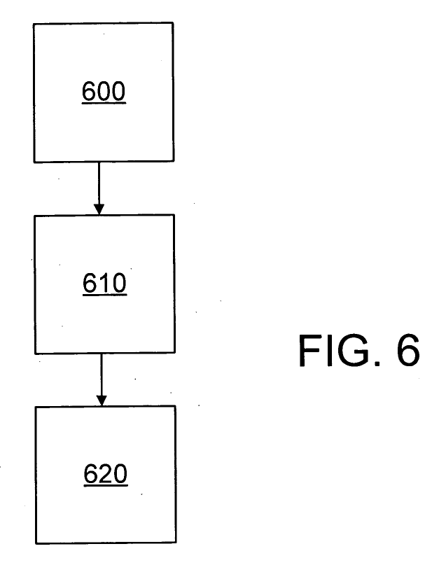

Designing a speaker independent multilingual isolated word recognition system according to the present invention includes a number of steps, as depicted in FIG. 6. At step 600, a suitable acoustic subword unit set that covers the languages of interest is selected. At step 610, the subword units are modeled using statistical modeling techniques such as hidden Markov models (HMM). The HMMs are trained offline using a large speech corpus recorded on multiple speakers and, if necessary or desired, multiple languages. The corpus is segmented, either manually or automatically, into subword units. These segments are used to train the acoustic models in a supervised or unsupervised manner. The trained acoustic models are then stored to be used later for recognition at step 620.

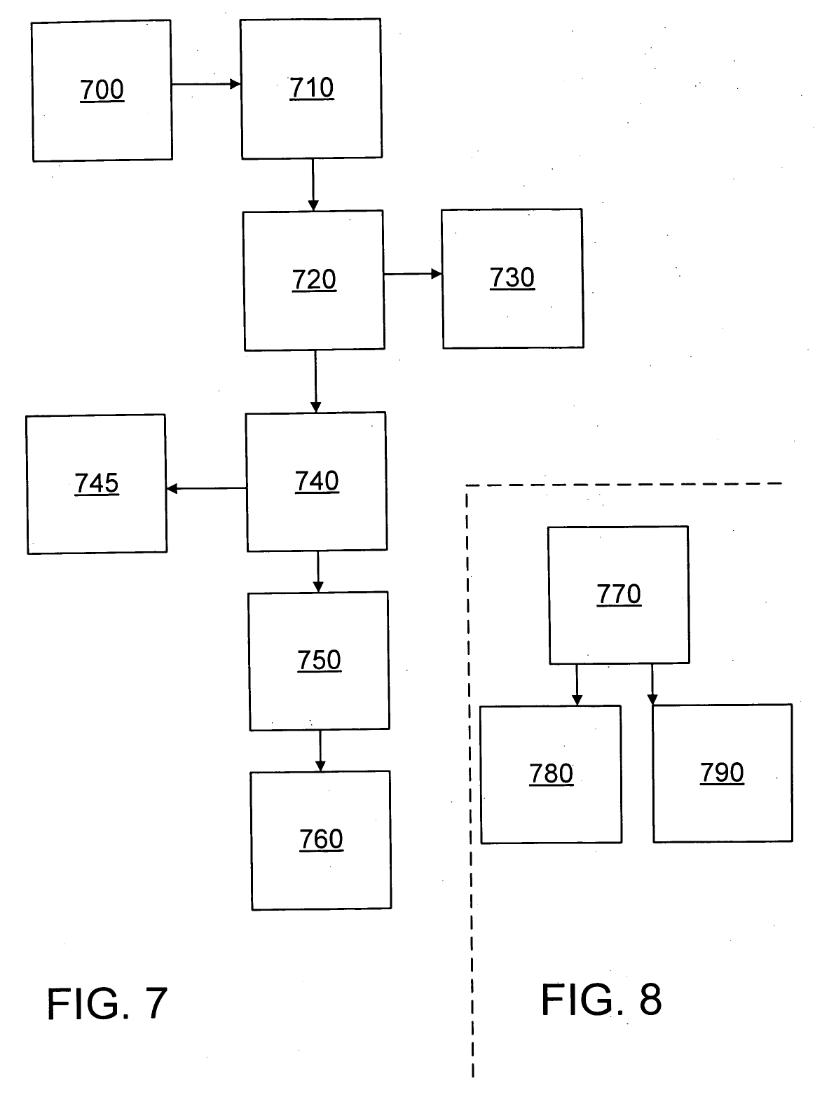

FIG. 7 is a flow chart showing the general process for the entering of a new word into a word recognition system. When a user desires the enabling voice dialing of names or commands, he or she enters the word at step 700 through a keypad or by other methods, such as automatically having the word read from a file. The language to which the word may belong is determined by a language identification method at step 710. For each likely language, a pronunciation is generated using a pronunciation-modeling system at step 720. Each pronunciation includes a sequence of subword units. These units together are also known as a transcription of the word. If the word being entered is the first word in the vocabulary, the transcription is stored in the device at step 730. If there is already a transcription stored in the device, the new transcription is compared to the stored transcription using the method of the present invention. This is repeated for each new entry.

The distance between two transcriptions is computed at step 740 by calculating the distances between the acoustic models corresponding to the subword units in the transcription. If the distance between the two transcriptions is less than a predefined threshold, then the user is notified of a possible confusion at step 750. The user can then choose an alternative word for either entry or both of the entries at step 760. If the distance between the two transcriptions is not less than the predefined threshold, then the transcription is stored within the device.

Later, when the user wants to dial a name or activate an item in the menu using one of the words entered earlier, he or she speaks the word at step 770 as represented in FIG. 8. The recognizer finds the most likely word using a stochastic matching method at step 780. The spoken word is also used to adapt the stored subword acoustic models at step 790. This changes the acoustic model parameters. Thus, the confusion among the words in vocabulary may be different at this point. The distance between stored transcriptions are computed each time that the models are adapted. In one embodiment of the invention, this recomputation occurs during the idle time of the recognizer and therefore does not increase the computational load of the recognizer. The user then is notified of the updated confusions among words and the user can take suitable action if necessary or desired.

The present invention can also be used to measure the “degree of difficulty” of a given vocabulary while developing multilingual, speaker-independent speech recognition systems. As a basic tool, the confusion measure on an entire vocabulary can be broadly defined as the perplexity of vocabulary since it describes how confusing is the particular vocabulary.

It should be noted that the list of applications mentioned herein is not intended to be exhaustive, but instead is only indicative of the present invention's use in designing an improved speech recognition system. The following is a discussion of one such method of computing the distance between two transcriptions based upon the distance between acoustic models.

A string edit distance metric is used to calculate the distance between transcriptions of words in one embodiment of the invention. One example of string edit distance is Levenshtein distance. Levenshtein distance is defined as the minimum cost of transforming one string into another by a sequence of basic transformations: insertion, deletion and substitution. The transformation cost is determined by the cost assigned to each basic transformation. The following demonstrates the use of Levenshtein distance in conjunction with the present invention. However, it should be understood that any string edit distance mechanism can be used. In the discussion below a phoneme is used as an example a of subword unit.

In this situation, x and y are phoneme sequences of length m and n, respectively, whose phonemes belong to a finite phoneme set of size s. xᵢ is the i-th phoneme of sequence x, with 1≦i≦m, and x(i) is the prefix of the sequence x of length i, i.e. the sub-sequence containing the first i phonemes of x. c(i,j) is the distance between x(i) and y(j), and ε is the silence or pause phoneme. The cost of substituting the phoneme a with the phoneme b, the cost of deleting a and the cost of inserting b, respectively by w(a,b), w(a, ε) and w(ε,b), respectively. The distance c(m,n) is recursively computed based upon the definitions of c(0,0), c(1,0) and c(0,j) (i=1 . . . m, j=1 . . . n), representing the initial distance, the cost of deleting the prefix x(i) and the cost of inserting the prefix y(j), respectively, as follows:

$$\begin{matrix}\begin{matrix}c ( 0 , 0 ) = 0 & \\ c ( i , 0 ) = c ( i - 1 , 0 ) + w ( {x}_{i} , ɛ ) & ∀ i = 1 … , m \\ c ( 0 , j ) = c ( 0 , j - 1 ) + w ( ɛ , {y}_{j} ) & ∀ j = 1 … , n\end{matrix} & ( 1 ) \\ c ( i , j ) = min \{ \begin{matrix}c ( i - 1 , j ) + w ( {x}_{i} , ɛ ) \\ c ( i , j - 1 ) + w ( ɛ , {y}_{j} ) \\ c ( i - 1 , j - 1 ) + w ( {x}_{i} , {y}_{j} )\end{matrix} & ( 2 )\end{matrix}$$

As discussed previously, the original Levenshtein distance is characterized by the following costs: w(a, ε)=1, w(ε, b)=1, and w(a, b) is 0 if a is equal to b and 1 otherwise. Its generalized version assumes that different costs can be associated to transformations involving different phonemes by using the confusion matrix w(a,b). In the case of a phoneme set of size s, this requires a table of size (s+1) times (s+1), called the confusion matrix, to store all the substitution, insertion and deletion costs. It can be shown that the defined distance is a metric if the confusion table is symmetric. The generalized Levenshtein distance c(x,y) is defined as the entry confusion measure in the present invention.

In Equation (2), the confusion matrix is required for calculation of the insertion, deletion and substitution costs. There are a number of different approaches available to calculate the confusion matrix. These approaches can be generally divided into two classes: data-driven and model-driven. For dealing with adaptation systems and lower computational complexity, the model-driven approach may be more suitable for the present invention.

In a situation where there are m entries in the vocabulary and the i-th entry is denoted by xᵢ, the perplexity of the vocabulary is designated as:

$$PP = \frac{2 \cdot {\sum }_{i = 1}^{m} {\sum }_{j > i}^{m} c ( {x}_{i} , {x}_{j} )}{m \cdot ( m - 1 )} \qquad ( 3 )$$

In the data driven method, given a pair of two phonemic HMMs, λᵢ and λⱼ, trained from speech, the likelihood based distance measure between model pair λᵢ and λⱼ is:

$$\begin{matrix}d ( {λ}_{i} , {λ}_{j} ) = \frac{\vert P ( {o}_{i} \vert {λ}_{i} ) - P ( {o}_{i} \vert {λ}_{j} ) \vert}{{N}_{i}} & ( 4 ) \\ d ( {λ}_{j} , {λ}_{i} ) = \frac{\vert P ( {o}_{j} \vert {λ}_{j} ) - P ( {o}_{j} \vert {λ}_{i} ) \vert}{{N}_{j}} & ( 5 )\end{matrix}$$

In these equations, oᵢ, and oⱼ are the observation sequences corresponding to phoneme i and phoneme j in the phoneme set. Nᵢ and Nⱼ are the length of the observation sequences. Because the distance measure of Equations (3) and (4) are not symmetric, the final cost in the confusion matrix is defined to be

$$w ( {λ}_{i} , {λ}_{j} ) = \frac{d ( {λ}_{i} , {λ}_{j} ) + d ( {λ}_{j} , {λ}_{i} )}{2} \qquad ( 6 )$$

In the model driven method, the confusion measure between a HMM model pair can be calculated by several different algorithms. One representative algorithm is presented below. Given a pair of two phonemic HMMs, λᵢ and λⱼ trained from speech, the cost in the confusion matrix is based upon phoneme distance measurements on Gaussian mixture density models of S states per phoneme, where each state of a phoneme is described by a mixture of N Gaussian probabilities. Each density m has a mixture weight wₘ and is represented by the L component mean and standard vectors μₘ and σₘ. Therefore,

$$\begin{matrix}d ( {λ}_{i} , {λ}_{j} ) = {\sum }_{i = 1}^{S} {\sum }_{m = 1}^{{N}_{i , j}} {w}_{m}^{( i , j )} \cdot {min}_{0 < n \leq {N}_{j , i}} {\sum }_{k = 1}^{L} {( \frac{{μ}_{m , k}^{( i , j )} - {μ}_{n , k}^{( j , i )}}{{σ}_{n , k}^{( j , i )}} )}^{2} & ( 7 ) \\ w ( {λ}_{i} , {λ}_{j} ) = \frac{d ( {λ}_{i} , {λ}_{j} ) + d ( {λ}_{j} , {λ}_{i} )}{2} & ( 8 )\end{matrix}$$

This can be understood as a geometric confusion measurement. However, it is also closely related to a symmetrised approximation to the expected negative log-likelihood score of feature vectors emitted by one of the phoneme models on the other, where the mixture weight contribution is neglected.

As explained above, a confusion measure between any pair of transcriptions can be calculated using a string edit distance as in Equation (2). This requires the calculation of the phoneme-based confusion matrix. The model-driven method discussed above is just one method of obtaining the phoneme-based model confusion matrix. The model-based approach can be calculated efficiently with low memory and computational resources.

The present invention can be used in a wide variety of applications. For each application, the usage of the application can be made simpler and easier with the present invention. For example, the confusable measure can be combined with the user's statistical information together to prune out the vocabulary in an automatic manner. The confusable information can be shown to the user as a message, and the user can use “yes” or “no” options to react to the message. A wide variety of user interfaces can be used to accomplish this task. The following cases illustrate a few ways in which the present invention may be used.

Sample Phonebook Situation: A particular phonebook can include the names “Bill Clinton,” “George Bush,” “Tony Blair” and “Jukka Häkkinen.” In the event that the user wishes to add the new name “John Smith,” it may not be confused with any of the existing words due to the very low degree of similarity with the existing names. If, on the other hand, the user wants to add new name “Juha Häkkinen,” then the present invention may report a possible confusion between “Juha Häkkinen” and “Jukka Häkkinen.” If the user were to alter the new name, this could greatly reduce the likelihood of potential confusion. For example, the name dialing performance of the phonebook application could be greatly improved if the user altered the new name to “Juha Häkkinen Runner.” Otherwise the system could undergo many errors because of the high similarity between “Jukka Häkkinen” and “Juha Häkkinen.”

Non-Native Speakers: For an adaptive phoneme-based, speaker-independent name dialing application in a mobile telephone, the phoneme HMM models are updated on-line. The vocabulary confusability can also be checked offline on a regular basis. The names that are not likely confusable may later become confusable after HMM models are adapted to a specific speaker. For some speakers, particularly non-native speakers, some of phonemes are indistinguishable. For example, the phonemes “r” and “rr”, as well as “s” and “z”, can be difficult to distinguish when a non-native speaker is involved. This issue makes some names, initially not confusable in speaker-independent models, confusable after adaptation.

Multilingual Scenarios: For multilingual, speaker-independent name dialing systems, the performance can compared between various languages, such as English and German. There are 100 names for testing of each language in this example. However, it may not be appropriate to valuate the recognition performance in such a case if the English vocabulary contains more confusable names then the German vocabulary. With the present invention, the average confusion measure can be made to guide the vocabulary design or explain the result in a more reasonable way than not taking this fact into account.

The present invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method of measuring confusion between word sequences in a word sequence recognition system, comprising:
having a new word sequence entered into an electronic device;
creating a new transcription of the new word sequence using a pronunciation-modeling system;
computing a distance between the new transcription and at least one prior transcription of a prior word sequence stored in a database if such a prior transcription exists; and
if the computed distance is less than a predefined threshold, informing a user of a potential confusion between the new word sequence and the prior word sequence.

2. The method of claim 1, further comprising, before the new transcription is created, determining languages to which the new word sequence likely belongs, and wherein a transcription is created for the new word sequence in each of the likely languages.

3. The method of claim 1, further comprising, if no prior transcriptions exist, adding the new transcription to the database.

4. The method of claim 1, further comprising, after the user is informed of the potential confusion, permitting the user to choose an alternative word sequence for at least one of the new word sequence and the prior word sequence.

5. The method of claim 1, wherein the word sequence recognition system is formed by:
selecting an acoustic subword unit set covering languages of interest;
modeling subword units for the language using a statistical modeling technique; and
storing the trained acoustic models for use in later recognition.

6. The method of claim 5, wherein the statistical modeling technique involves the use of hidden Markov models which are trained offline using a large speech corpus, and wherein the large speech corpus is segmented into the subword unit set.

7. The method of claim 1, wherein the distance is computed between the new transcription and at least one prior transcription of a prior word sequence using a string edit distance metric.

8. The method of claim 7, wherein the string edit distance comprises a Levenshtein distance.

9. A computer program product for measuring confusion between word sequences in a word sequence recognition system, comprising:
computer code for having a new word sequence entered into an electronic device;
computer code for creating a new transcription of the new word sequence using a pronunciation-modeling system;
computer code for computing a distance between the new transcription and at least one prior transcription of a prior word sequence stored in a database if such a prior transcription exists; and
computer code for, if the computed distance is less than a predefined threshold, informing a user of a potential confusion between the new word sequence and the prior word sequence.

10. The computer program product of claim 9, further comprising computer code for, before the new transcription is created, determining languages to which the new word sequence likely belongs, and wherein a transcription is created for the new word sequence in each of the likely languages.

11. The computer program product of claim 9, further comprising computer code for, if no prior transcriptions exist, adding the new transcription to the database.

12. The computer program product of claim 9, further comprising computer code for, after the user is informed of the potential confusion, permitting the user to choose an alternative word sequence for at least one of the new word sequence and the prior word sequence.

13. The computer program product of claim 9, wherein the word sequence recognition system is formed by:
selecting an acoustic subword unit set covering languages of interest;
modeling subword units for the language using a statistical modeling technique; and
storing the trained acoustic models for use in later recognition.

14. The computer program product of claim 13, wherein the statistical modeling technique involves the use of hidden Markov models which are trained offline using a large speech corpus, and wherein the large speech corpus is segmented into the subword unit set.

15. The computer program product of claim 9, wherein the distance is computed between the new transcription and at least one prior transcription of a prior word sequence using a string edit distance metric.

16. The computer program product of claim 15, wherein the string edit distance comprises a Levenshtein distance.

17. An electronic device, comprising:
a processor; and
a memory unit communicatively connected to the processor and including a computer program product for measuring confusion between word sequences in a word sequence recognition system, the computer program product including:
computer code for having a new word sequence entered into the electronic device;
computer code for creating a new transcription of the new word sequence using a pronunciation-modeling system;
computer code for computing a distance between the new transcription and at least one prior transcription of a prior word sequence stored in a database if such a prior transcription exists; and
computer code for, if the computed distance is less than a predefined threshold, informing a user of a potential confusion between the new word sequence and the at least one prior word sequence.

18. The electronic device of claim 17, wherein the memory unit further includes computer code for, before the new transcription is created, determining languages to which the new word sequence likely belongs, and wherein a transcription is created for the new word sequence in each of the likely languages.

19. The electronic device of claim 17, wherein the word sequence recognition system is formed by:
selecting an acoustic subword unit set covering languages of interest;
modeling subword units for the language using a statistical modeling technique; and
storing the trained acoustic models for use in later recognition.

20. The electronic device of claim 17, wherein the distance is computed between the new transcription and at least one prior transcription of a prior word sequence using a string edit distance metric.
